(19) United States
(12) Patent Application Publication
(10) Pub. No.: US 2012/0193383 A1
(43) Pub. Date: Aug. 2, 2012

(54) ASSIST GRIP HANDLE INTEGRATED CLOTHESLINE ASSEMBLY

(75) Inventor: Adam Michael Ludwig, Ann Arbor, MI (US)

(73) Assignee: Toyota Motor Engineering & Manufacturing North America, Inc., Erlanger, KY (US)

(21) Appl. No.: 13/016,047

(22) Filed: Jan. 28, 2011

(51) Int. Cl. B60R 7/00

(52) U.S. Cl. 224/539

(57) ABSTRACT

An integrated clothesline assembly, for supporting garments between two opposing surfaces, includes an assist grip handle attached to one of the two surfaces. The assist grip handle includes a body portion adapted to be gripped by a user, and at least one attachment portion to secure the assist grip handle to one of the surfaces. A retractable cord is disposed within the assist grip handle. The retractable cord includes a free end, and is positionable between a retracted position and an extended position. In the retracted position, the free end is positioned adjacent an outer surface of the assist grip handle, and in the extended position the free end is positioned remote from the assist grip handle.

### FIELD OF THE INVENTION

The present invention relates to a vehicle integrated clothesline assembly for use in an automotive vehicle. More particularly, to a clothesline assembly which is integrated into an assist grip handle attached to a roof of the vehicle, and which deploys to extend across the width of the vehicle.

### BACKGROUND OF THE INVENTION

It is known to provide the passenger compartment of an automotive vehicle with a garment hanging device such as a coat hook. The previously known garment hanging devices are typically attached to a headliner portion of the automotive vehicle and used to store a limited number of garments. However, in order to provide an aesthetically pleasing appearance to the passenger compartment of the automotive vehicle, previously known coat hooks are typically small in size and therefore are limited in the number of garments which can be supported.

In order to provide the passenger compartment of an automotive vehicle with additional garment hanging space, it is known in the art to provide a garment support which extends the width of the vehicle. For example, U.S. Pat. No. 5,147,078 to Flieder discloses a retractable clothesline assembly having a housing hook which attaches to a coat hook of the headliner. A retractable cord is extended from the clothesline across the width of the vehicle and attached to an opposing coat hanger.

Further, U.S. Pat. No. 2,629,528 to Vealey; U.S. Pat. No. 2,969,881 to Lilly; and U.S. Pat. No. 2,524,743 to Wright each disclose a garment hanger which extends the width of the vehicle to provide additional space for hanging. However, each of these previously known garment supports are an additional item which must be stored during periods of nonuse thereby taking up valuable storage space of the automotive vehicle. In the alternative, the garment supports must optionally be stored outside the vehicle and are only useable when the occupant has access to the external stored garment support.

In addition, U.S. Pat. No. 6,315,357 to Johnston discloses a retractable garment support which is formed as part of the headliner assembly. However, the retractable garment hanger assembly of the Johnston patent increases the amount of parts and components of the vehicle. As such, the inclusion of the retractable garment support incurs additional labor and component costs which increase the overall cost of the vehicle.

Thus, there exists a need for an improved garment support provided within an automotive vehicle which is integrally formed and does not increase the amount of additional parts or required installation time.

### SUMMARY OF THE INVENTION

The present invention provides an improved vehicle integrated clothesline assembly which overcomes the above-mentioned disadvantages of the previously known garment hanging devices provided in an automotive vehicle.

In brief, an integrated clothesline assembly for supporting garments between two opposing surfaces is provided. The integrated clothesline assembly includes an assist grip handle attached to one of the two surfaces. The assist grip handle includes a body portion adapted to be gripped by a user, and at least one attachment portion to secure the assist grip handle to one of the surfaces. A retractable cord is disposed within the assist grip handle. The retractable cord includes a free end, and is positionable between a retracted position and an extended position. In the retracted position, the free end is positioned adjacent an outer surface of the assist grip handle, and in the extended position the free end is positioned remote from the assist grip handle.

In one embodiment of the invention, the retractable cord is disposed within a body portion of the assist grip handle. The retractable cord includes a connector attached to the free end. The assist grip handle includes a cavity formed in the exterior surface through which the retractable cord extends when positioned in the extended position. In the retracted position, the connector is received within the cavity of the assist grip handle and extends flush with an exterior of the assist grip handle.

The integrated clothesline assembly further includes a second assist grip handle located on the other of the two surfaces. The second assist grip handle includes a port for receiving the connector positioned on the free end of the retractable cord when the retractable cord is in the extended position. The port on the second assist grip handle includes a plug having a complementary shape to the port such that the plug extends flush with an exterior of the second assist grip handle when the plug is received within the port.

One advantage of the present invention is that the integrated clothesline assembly is installed within the vehicle through the installation of the assist grip handle. As such, the assembly time of the vehicle is not increased as the installation of the assist grip handle simultaneously installs the clothesline assembly. A further advantage of the present invention is that the clothesline assembly is readily available to an occupant and does not require the use of valuable storage space as the clothesline assembly is integrated into the assist grip handle.

### BRIEF DESCRIPTION OF THE DRAWINGS

A better understanding of the present invention will be had upon reference to the following detailed description when read in conjunction with the accompanying drawings wherein like reference characters refer to like parts throughout the several views and in which:

FIG. 1 is a partial cross-sectional view illustrating an automotive vehicle having the inventive integrated clothesline assembly;

FIG. 2A is a partial perspective view illustrating an assist grip handle of the integrated clothesline assembly in the stowed position;

FIG. 2B is a partial perspective view illustrating an assist grip handle of the integrated clothesline assembly in the use position;

FIG. 3 illustrates a partial perspective view of an assist grip handle of the inventive integrated clothesline assembly with a retractable cord in the extended position and engaged with a connection member;

FIG. 4 is a partial perspective view of an assist grip handle of the inventive integrated clothesline assembly with a retractable cord in an extended position and engaged with an alternative connection member;

FIG. 5 is a partial perspective view of an assist grip handle of the inventive integrated clothesline assembly having a retractable cord in an extended position and engaged with a modified alternative connection member;

FIG. 6 is a partial perspective view of an alternative embodiment of the inventive integrated clothesline assembly having retractable cords in opposing grip assist handles;

FIG. 7 is a partial cross-sectional view of the connection member taken along line 7-7 of FIGS. 5; and

FIG. 8 is a partial cross-sectional view of the retractable cord taken along line 8-8 of FIG. 5.

### DETAILED DESCRIPTION OF THE INVENTION

The present invention has utility as an integrated clothesline assembly for use in an automotive vehicle which overcomes the above-mentioned disadvantages. By providing a retractable cord disposed within an assist grip handle, the clothesline assembly is integrated into the passenger compartment of the vehicle. As such, the clothesline assembly is not required to be stowed within a storage space of the vehicle or an external storage space. Accordingly, the inventive integrated clothesline assembly is easily available to the occupant and reduces installation time.

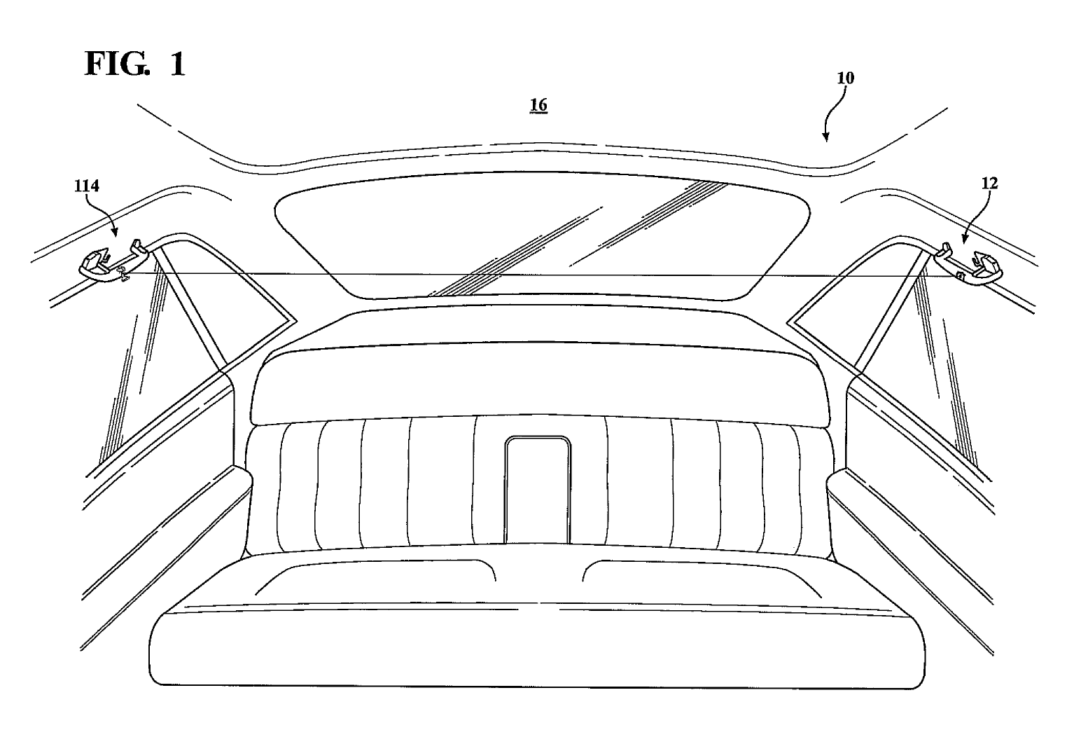

With reference to FIG. 1, an integrated clothesline assembly generally illustrated at 10 is positioned within an interior passenger compartment of an automotive vehicle. A first assist grip handle 12 and a second assist grip handle 114 are provided on opposing sides of a roof portion 16 in the vehicle width direction. The roof portion 16 includes the vehicle headliner and the roof of the vehicle body. The first assist grip handle 12 and the second assist grip handle 114 are secured to the roof portion 16. It is appreciated, of course, that the first assist grip handle 12 and the second assist grip handle 114 are optionally secured to the headliner portion, the vehicle body roof portion, or both.

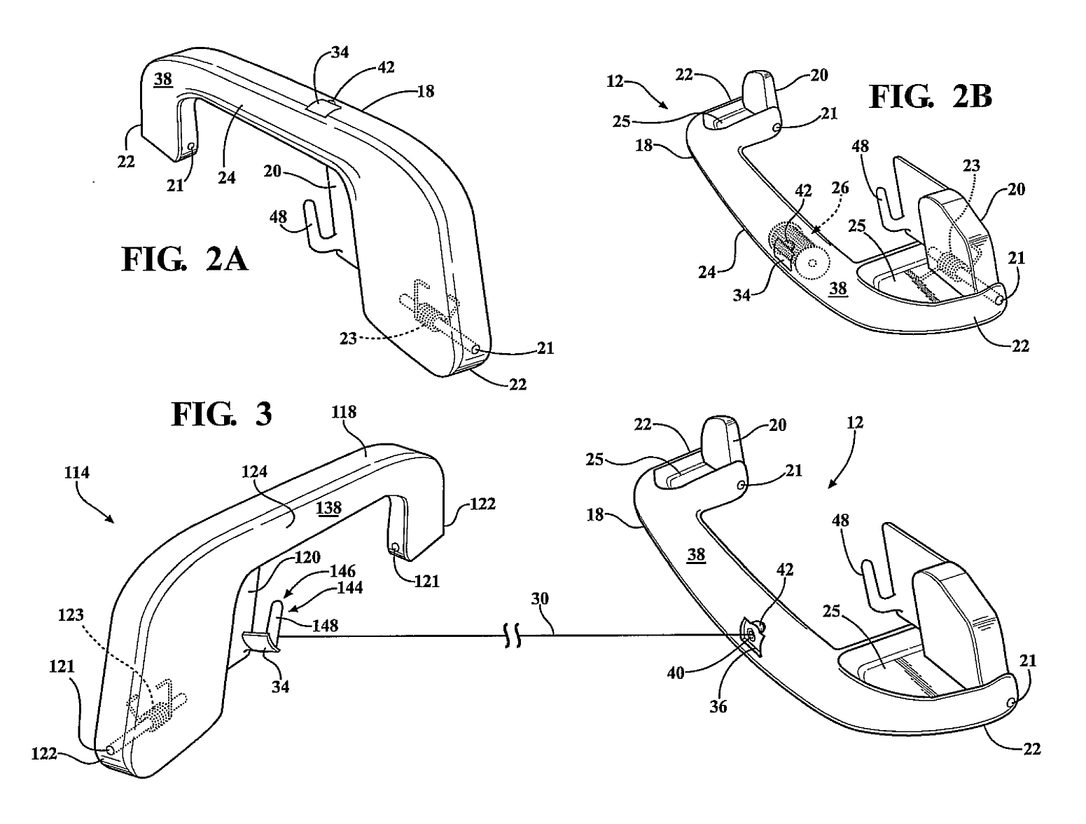

With reference to FIG. 2, the first assist grip handle 12 includes a handle 18 and a pair of attachment plates 20. The handle portion 18 has a generally C shape having a pair of end portions 22 extending from either end of a body portion 24. Each of the end portions 22 is hingedly attached to one of the attachment plates 20 by pins 21 in order to secure the handle 18 to the roof portion 16 of the automotive vehicle. The end portions 22 include recesses 25 dimensioned to receive the attachment plates 20 when the handle 18 is positioned in stowed position as seen in FIG. 2A.

A biasing member 23 is positioned between the end portions 22 and attachment plates 20 to bias the handle 18 about pins 21 from a use position shown in FIG. 2B towards the stowed position. In the illustrated embodiment, a single biasing member 23 is used to biasing the handle 18 towards the stowed position, although, the first assist grip handle optionally includes a biasing member 23 disposed at both end portions 22. In the use position, the user grips the body portion 24 of the handle 18 to provide additional stability, or assistance during ingress or egress of the vehicle.

A retracting device 26 is positioned within the body portion 24 of the first assist handle 12. As best seen in FIG. 8, the retracting device 26 is positioned within a hollow interior 28 formed within the body portion 24. The retracting device 26 includes a retractable cord 30 having a free end and a spring-loaded spool 32. The spool 32 is supported on and rotates about post 27 fixed to the hollow interior 28. A first end 29 of spring 31 engages with the fixed post 27. A second end 33 of the spring 31 is inserted into a post 35 formed within the spool 32. As the free end of the retractable cord 30 is pulled by a user, the spool 32 rotates and winds spring 31 under tension so as to retract the retractable cord 30 back to the retracted position. It is appreciated that the retractable cord 30 is retractable by any known means to those of ordinary skill in the art including various types of spring loaded reels and power re-winders.

A connector 34 is attached to the free end of the retractable cord 30. An opposite fixed end is operatively attached to the hollow interior 28 via the spool 32. The retractable cord 30 is optionally dimensioned a specific predetermined length to tautly extend across the passenger compartment. The retractable cord 30 is optionally formed of any flexible material either woven or non-woven materials.

A cavity 36 is formed on the exterior surface 38 of the body portion 24 to receive the connector 24. The cavity 36 is formed such that an outer face of the connector 34 extends flush with the exterior surface 38 of the body portion 24 when the connector 34 is received within the cavity 36, as seen in FIG. 2. A through hole 40 extends from the hollow interior 28 to the cavity 36 and a portion of the retractable cord 30 extends through the through hole 36. An indent 42 is positioned adjacent the cavity 36. The indent 42 is used in disengaging the connector 34 from the cavity 36, by providing an occupant with the easy ability to pry the connector 34 out of engagement with the cavity 36.

During periods of nonuse the retractable cord 30 is retractable into a retracted position in which retractable cord 30 is wound around the spool 32 and the connector 34 is received within the cavity 36. The cavity 36 is positioned on a top side of the handle body portion 24 such that when the retractable cord 30 is in the retracted position and the handle 18 is positioned in the stowed position, the connector 34 received within the cavity 36 is not visible to an occupant seated within the passenger compartment of the automotive vehicle.

The second assist grip handle 114 has a similar configuration as the first assist grip handle without the retractable device 26 and the cavity 36. The second assist grip handle 114 includes a handle 118 and a pair of attachment plates 120 for securing the second assist grip handle 114 to the roof portion 16. The handle 118 has a generally C shape having a pair of end portions 122 extending from either end of a body portion 124. As with the first assist grip handle 12, the end portions 122 are hingedly attached to one of the attachment plates 120 via the pins 121 and the biasing member 123. The second assist grip handle 114 includes a connection member 144.

In order to provide a clothesline for suspending garments within the passenger compartment of the automotive vehicle, the retractable cord is positionable into an extended position as seen in FIG. 3. In the extended position, the retractable cord 30 extends across the width of the passenger compartment of the vehicle to engage with the connection member 144. As discussed below, the engagement of the connector 34 with the connection member 144 provides a secure attachment to the opposing side of the vehicle allowing an occupant to utilize the extended retractable cord 30 as a clothesline or garment support.

With reference to FIG. 3, the connection member 144 is a coat hook 146 having a hook member 148 extending from an attachment plate 120 of the second assist grip handle 114. In order to connect the connector 34 with the coat hook 146, a portion of the retractable cord 30 adjacent the connector 34 is positioned in between the hook member 148 and the attachment plate 120. The engagement of the connector 34 with the coat hook 146 restricts the movement of the retractable cord 30 from the extended position to the retracted position and secures the retractable cord 30 for use as a clothesline.

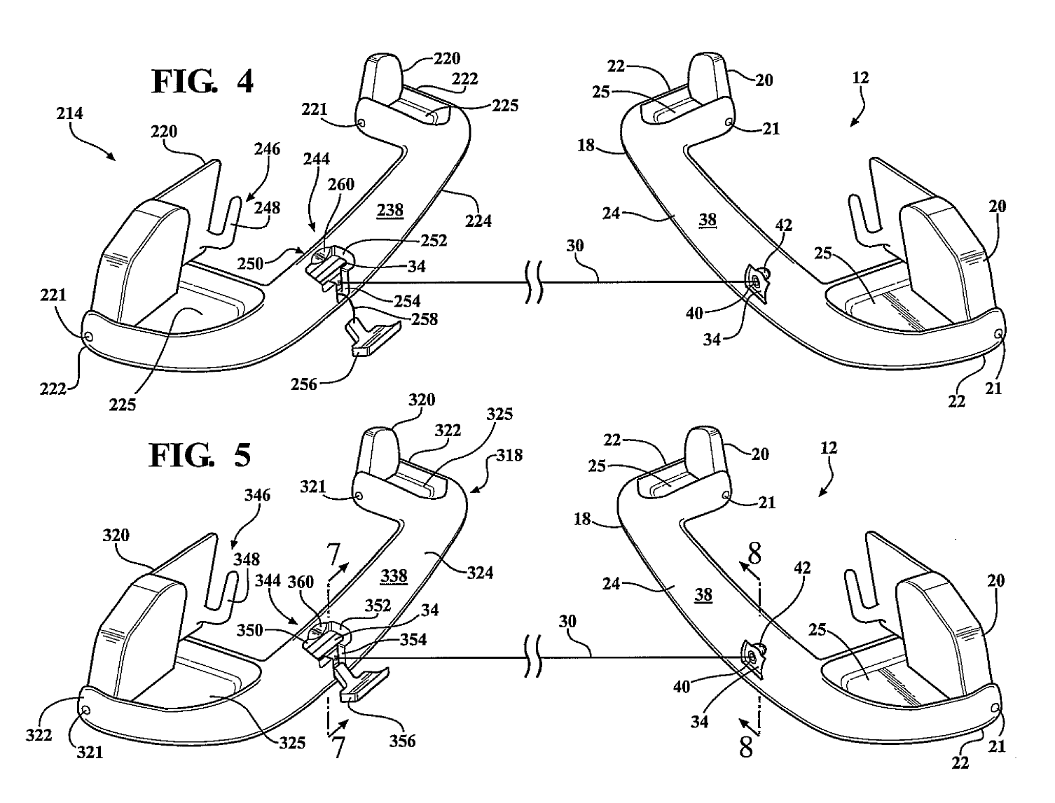

With reference to FIG. 4, an alternative configuration of the connection member is generally illustrated at 244. The connection member 244 is located on the second assist grip handle 214. The connector member 244 includes a port 250 formed as a cavity in the body portion 224 of the second assist handle 214. The port 250 includes a first region 252 configured to receive the connector 34 within the interior of the body portion 224. A second region 254, in communication with the first region 252, is sized smaller than the connector 34 but larger than the portion of the retractable cord 30 adjacent the connector 34. The configuration of the port 250 restrains the connector 34 within the cavity formed in the body portion 224 of the second assist grip handle 244 and restricts the movement of the retractable 30 from the extended position to the retracted position.

The connection member 244 further includes a plug 256 having a complementary shape to the port 250 including the first region 252 and the second region 254. The plug 256 is received within the port 250 such that an outer face of the plug 256 extends flush with the exterior surface 238 of the body portion 224. A tether 258 has one end attached to an inner face of the plug 256 and an opposite end attached within the port 250 so as to secure the plug 256 to the body portion 224 when the plug 256 has been removed from the port 250. An indent 260 is formed adjacent the port 250 so as to provide an occupant with the easy ability to pry the plug 256 out of engagement with the port 250.

With reference to FIG. 5, an additional alternative configuration of the connection member disposed on the second assist grip handle 314 is generally illustrated at 344. The connection member 344 is substantially similar to the connection member 244 without the tether 258. The connection member 344 is pivotally attached to the body portion 324. As best seen in FIG. 7, a pin 360 extends through a plug 356 in order to pivot the plug 356 between an engaged position and a disengaged position (as seen in ghost).

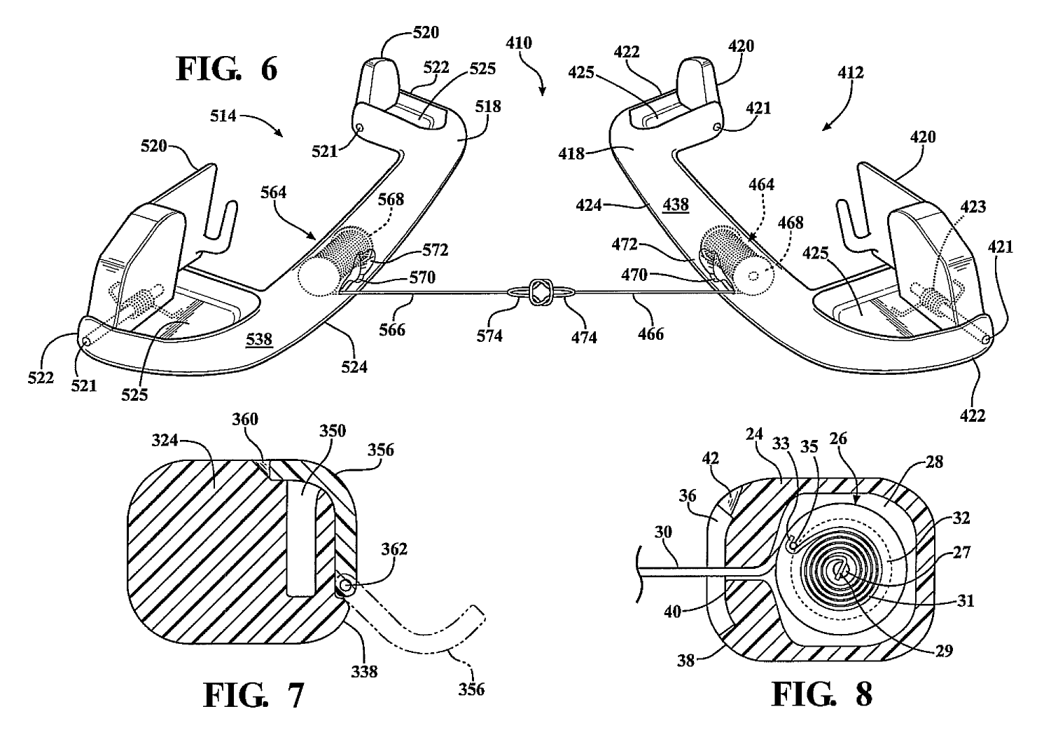

With reference to FIG. 6, a second embodiment of the integrated clothesline assembly is generally illustrated at 410. The integrated clothesline assembly 410 includes a first assist grip handle 412 and a second assist grip handle 514 disposed on an opposite side of the passenger compartment in the vehicle width direction. The second assist grip handle 514 being a mirror image of the first assist grip handle 412.

The first assist grip handle 412 includes a retractable device 464 having a retractable cord 466 and a conventional spring-loaded spool 468 positioned within a cavity formed in the body portion 424 of the handle 418. An aperture 470 having a flap 472 is formed in the body portion 424 in order to allow the retractable cord 466 to extend outside the cavity formed in the body portion 424. A connector 474 is attached to a terminal end of the retractable cord 466. The flap 472 covers the aperture 470 when the retractable cord 466 is in the retracted position with the connector 474 positioned within the aperture 470.

The second assist handle 514 is a counterpart of the first assist grip handle 412, and includes retractable device 564 having a retractable cord 566 and a conventional spring-loaded spool 568 positioned within a cavity formed in the body portion 524 of the handle 518. An aperture 570 having a flap 572 is formed in the body portion 524 in order to allow the retractable cord 566 to extend outside the cavity formed in the body portion 524. A connector 574 is attached to a terminal end of the retractable cord 566. The flap 572 covers the aperture 570 when the retractable cord 566 is in the retracted position with the connector 574 positioned within the aperture 570.

The retractable cords 466 and 566 are positionable between a retracted position and an extended position. In the retracted position the retractable cords 466 and 566 are wound around the spools 468 and 568, respectively, and the connectors 474 and 574 are received within the apertures 470 and 570, respectively. In the extended position the retractable cords 466 and 566 extend partially across the passenger compartment in the vehicle width direction. When in the extended position, the connector 474 and the connector 574 engage midway in the passenger compartment in order to provide a clothesline which extends across the passenger compartment in the vehicle width direction.

In the illustrated embodiment the connector 474 and the connector 574 include complementary engagement portions which interact with each other to secure the retractable cord 466 to the retractable cord 566. It is appreciated, of course, that the connector 474 and the connector 574 are optionally include a hook-and-eye, stud-and-loop configuration or any other known configuration to mate one connector with another. For example, the connector 474 optionally includes a female threaded portion while the connector 574 includes a complementary male threaded portion which engages with the connector 474 to secure the retractable cord 466 to the retractable cord 566 in order to provide a clothesline extending across the width of the vehicle.

The placement of the retracting device 464 and 564 within the first grip assist handle 412 and the second grip assist handle 514 rather than just a single retracting device in one handle reduces the overall length the retractable cords 466 and 566 have to extend in order to engage. By reducing the length of the retractable cords 466 and 566, the size of the spools 468 and 568 is also reduced. The reduction in the size of the spools 468 and 568 allows the retractable devices 464 and 564 to become more compact and easily fit within the body portions 424 and 524 without distorting the size of the handles 418 and 518.

In order to minimize the congregation of hanging garments towards the middle span of the retractable cord 30 in the vehicle width direction due to slack in the retractable cord 30 or a surplus of retractable cord 30, the retractable cord 30 is dimensioned so as to only be slightly longer than the length required to extend from the first assist grip handle 12 to the connection member thereby limiting the amount of slack in the clothesline. In addition, the length of the retractable cords 466 and 566 is similarly dimensioned so as to only extend slightly beyond the middle portion of the passenger compartment of the vehicle. The spools are optionally spring loaded such that the retractable 30 cord or retractable cords 466 and 566 are under tension towards the retracted position to withstand the weight of the hanging garments without pooling or drooping in the middle. It is appreciated, that the retractable devices 464 and 564 are configured similar to the retractable device 26; however, such configuration is non-limiting, and the retractable devices 26, 464 and 564 are optionally any conventional retractable device to retract and wind a cord.

In the alternative, a lock mechanism is optionally attached to the first assist grip handle 12, the first assist grip handle 412, and or second assist grip handle 514 in order to lock the retractable cords 30 or 466 and 566 from extending beyond a predetermined amount thereby decreasing the amount of slack within the clothesline.

It is appreciated, of course, that the retractable cord is not limited to attachment to a connection member disposed on an opposite side in the vehicle width direction. The retractable cord optionally connects to a connection member spaced apart in the vehicle length direction, such as from an assist grip handle located in the second row of seating to an assist grip handle in a third row of seating along the same side of the vehicle. Further, the retractable cord optionally attached to a connection member spaced apart in the vehicle width direction and in the vehicle length direction, such as a retractable cord attached to an assist grip handle located in the second row of seating to connection member attached to an assist grip handle in a third row of seating on an opposite side of the vehicle.

It is appreciated, of course, that the integrated clothesline assembly described above, is not limited to use within a passenger compartment of an automotive vehicle. The integrated clothesline assembly is optionally used for supporting garments between two opposing surfaces. For example, the integrated clothesline assembly is using in a bathroom, with the first assist grip handle optionally disposed on a shower wall.

The present invention has been described in an illustrative manner. It is to be understood that the terminology which has been used is intended to be in the nature of words of description rather than limitation. Many modifications and variations of the present invention are possible in light of the above teachings. Therefore, within the scope of the appended claims, the present invention may be practiced other than as specifically described.

It is claimed:

1. An integrated clothesline assembly for supporting garments between two opposing surfaces, said integrated clothesline assembly comprising:
an assist grip handle having a body portion and at least one attachment portion secured to one of the surfaces, said body portion adapted to be gripped by a user; and
a retractable cord disposed within said assist grip handle, said retractable cord having a free end, said retractable cord positionable between a retracted position in which said free end is positioned adjacent an exterior surface of said assist grip handle and an extended position in which said free end is positioned remote from said assist grip handle.

2. The integrated clothesline assembly of claim 1, wherein a cavity is formed in said assist grip handle, and wherein said retractable cord includes a connector attached to said free end, said connector is positioned within said cavity when said retractable cord is in said refracted position.

3. The integrated clothesline assembly of claim 2, wherein said connector engages with a connection member disposed on the other of the surfaces.

4. The integrated clothesline assembly of claim 3, wherein said connector member is a second assist grip handle.

5. The integrated clothesline assembly of claim 4, wherein said second assist grip handle includes a port for receiving said connector of said retractable cord when said retractable cord is in said extended position.

6. The integrated clothesline assembly of claim 5, wherein said second assist grip handle includes a plug having a complementary shape to said port, and wherein said plug is received within said port such that said plug extends flush with an exterior of said second assist grip handle.

7. The integrated clothesline assembly of claim 6, wherein said plug is connected to said second assist grip handle by a tether.

8. The integrated clothesline assembly of claim 5, wherein said port has a first region and a second region in communication with said first region, said first region configured to receive said connector to engage said connector with said port, and wherein said second region is configured to receive said portion of said retractable cord and restrain said connector from disengaging with said port.

9. The integrated clothesline assembly of claim 8, wherein said first region is dimensioned to be larger than said connector, and said second region is dimensioned to be smaller than said connector and larger than a diameter of said retractable cord.

10. The integrated clothesline assembly of claim 3, wherein said connector member is a hook.

11. The integrated clothesline assembly of claim 6, wherein said plug is pivotally connected to said port.

12. The integrated clothesline assembly of claim 4, wherein said assist grip handle and said second assist grip handle are attached to opposite sides of a vehicle roof in the vehicle width direction.

13. An integrated clothesline assembly for supporting garments between opposite sides of a passenger compartment of a vehicle, said integrated clothesline assembly comprising:
an assist grip assist grip handle having a body portion and at least one attachment portion secured to one side of the passenger compartment of the vehicle; and
a retractable cord disposed within said assist grip handle, said retractable cord having a free end and a fixed end operatively secured within said assist grip handle, said retractable cord positionable between a retracted position in which said free end is positioned adjacent an outer surface of said assist grip handle and an extended position in which said free end is positioned remote from said assist grip handle.

14. The integrated clothesline assembly of claim 13, wherein a cavity is formed in said assist grip handle, and wherein said free end of said retractable cord includes a connector which is positioned within said cavity when said retractable cord is in said retracted position.

15. The integrated clothesline assembly of claim 14, wherein said connector engages with a connection member disposed on an opposite side of said passenger compartment in the vehicle width direction.

16. The integrated clothesline assembly of claim 15, wherein said connection member is a port formed on a second assist grip handle, said port receiving said connector of said retractable cord when said retractable cord is in said extended position.

17. The integrated clothesline assembly of claim 16, wherein said second assist grip handle includes a plug having a complementary shape to said port, said plug being received within said port, and wherein said plug is connected to said second assist grip handle by a tether.

18. The integrated clothesline assembly of claim 16, wherein said second assist grip handle includes a plug having a complementary shape to said port, said plug being received within said port, and wherein said plug is pivotally connected to said second assist grip handle by a tether.

19. The integrated clothesline assembly of claim 13, further comprising:
a second assist grip handle having a body portion and at least one attachment portion secured to the opposite side of the passenger compartment of the vehicle; and
a retractable cord disposed within said assist grip handle, said retractable cord positionable between a retracted position and an extended position;
wherein said retractable cord in said extended position engages with said second retractable cord in said extended position to form a clothesline traversing the passenger compartment of the vehicle.

20. The integrated clothesline assembly of claim 19, wherein said retractable cord includes a connector disposed at a free end of said retractable cord, and said second retractable cord includes a second connector disposed at a second free end of said second retractable cord, and wherein said connector engages with said second connector when said retractable cord and said second retractable cord are in said extended positions.
